(19) United States
(12) Patent Application Publication
(10) Pub. No.: US 2019/0203506 A1
(43) Pub. Date: Jul. 4, 2019

(54) Package anchor

(71) Applicant: Mitchell Calderwood, Las Vegas, NV (US)

(72) Inventor: Mitchell Calderwood, Las Vegas, NV (US)

(21) Appl. No.: 16/350,740

(22) Filed: Dec. 28, 2018

Related U.S. Application Data
(60) Provisional application No. 62/708,983, filed on Dec. 29, 2017.

(51) Int. Cl. E05B 73/00

(52) U.S. Cl. CPC E05B 73/0029; E05B 73/0005

(57) ABSTRACT

The present invention pertains to a package anchor for securing packages to exterior fixed objects such as doors. A package anchor system for attaching a package to a house with a fixed exterior object such as a doorknob, handle, railing or door frame. The anchor system has a staple attachable to the package. The strap is mounted to the staple. The strap has a width separating two wires and the wires are covered by plastic film with a center line of a plurality of holes. A zipper lock is placed on the strap and is slidable on the strap. The zipper lock has a first slot and a second slot with an internal tooth. Both the first slot and second slot have wire channels. The strap can alternatively be wound on a spool instead of attached to a staple at one end.

This application claims priority based on U.S. Provisional Pat. Appl. No. 62/708,983. Said patent application is incorporated herein by reference in its entirety.

### TECHNICAL FIELD

The present invention pertains to a package anchor for securing packages to exterior fixed objects such as doors.

### BACKGROUND ART

Currently, internet-based retail and wholesale delivery of merchandise is a fast growing commercial industry. A wide variety of goods are being shipped. These items range in value from very inexpensive to very expensive. Theft at the point of delivery has become an issue. Package theft has become an attractive crime of opportunity costing the online retail industry an estimated 900 million dollars in 2015 for the loss of some 15 million packages in the United States alone. Thus, a more effective theft deterrent is desired.

### SUMMARY OF THE INVENTION

The present invention pertains to a package anchor for securing packages to exterior fixed objects such as doors. A package anchor system for attaching a package to a house with a fixed exterior object such as a doorknob, handle, railing or door frame. The anchor system has a staple attachable to the package. The strap is mounted to the staple. The strap has a width separating two wires and the wires are covered by plastic film with a center line of a plurality of holes. A zipper lock is placed on the strap and is slidable on the strap. The zipper lock has a first slot and a second slot with an internal tooth. Both the first slot and second slot have wire channels. The strap can alternatively be wound on a spool instead of attached to a staple at one end.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective side view of a preferred embodiment of the invention;

FIG. 2A is a bottom view of a preferred embodiment of an anchor;

FIG. 2B is a side view of a preferred embodiment of an anchor;

FIG. 2C is a top view of a preferred embodiment of an anchor;

FIG. 3 is a top perspective view of an embodiment installed on an envelope;

FIG. 4 is a partial side perspective view of a preferred embodiment of a line and cinch;

FIG. 5 is a top perspective view of an alternative embodiment of the invention with a strap and spool and zipper lock;

FIG. 6 is a top perspective view of a preferred embodiment of the strap;

FIG. 7 is top perspective view of a preferred embodiment of the zipper lock;

FIG. 8 is a cross-sectional side view of a preferred embodiment of the zipper lock;

FIG. 9 is an end view of a preferred embodiment of the zipper lock;

FIG. 10 is a side perspective view of a preferred embodiment of a spool;

FIG. 11 is a top perspective view of a loop formed by the strap and zipper lock;

FIG. 12 is a top perspective view of a preferred embodiment of the invention installed on a box with a staple;

FIG. 13 is a top view of a preferred embodiment of the invention installed at four preferred installation points on a box;

FIG. 14 is a side view of a preferred embodiment of an attachment ring attached to a door;

FIG. 15 is a side view of a preferred embodiment of an attachment device on a door frame;

FIG. 16 is a side view of an alternative embodiment attachment device on a door; and,

FIG. 17 is a side view of an alternative embodiment attachment device uninstalled.

### DETAILED DESCRIPTION OF THE PREFERRED EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s). The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide an improved package anchor.

### Version 1

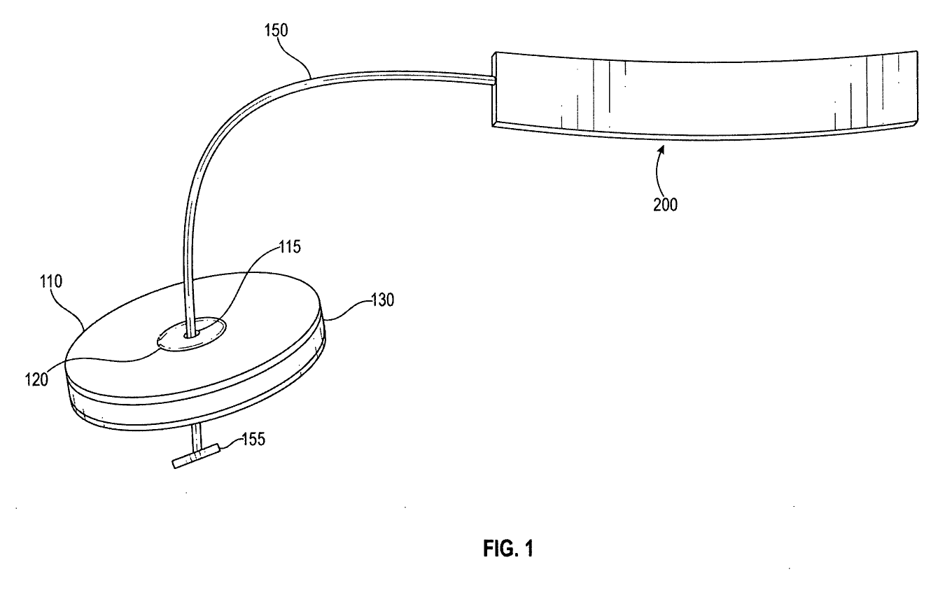

Referring now to FIG. 1, a perspective view of a preferred embodiment of the invention is shown. Preferably, the invention comprises an anchor 110 attached by a line 150 to a cinch 200. The cinch 200 can then be attached to a (relatively) difficult to move object such as a doorframe or fence or wall (not shown in FIG. 1.)

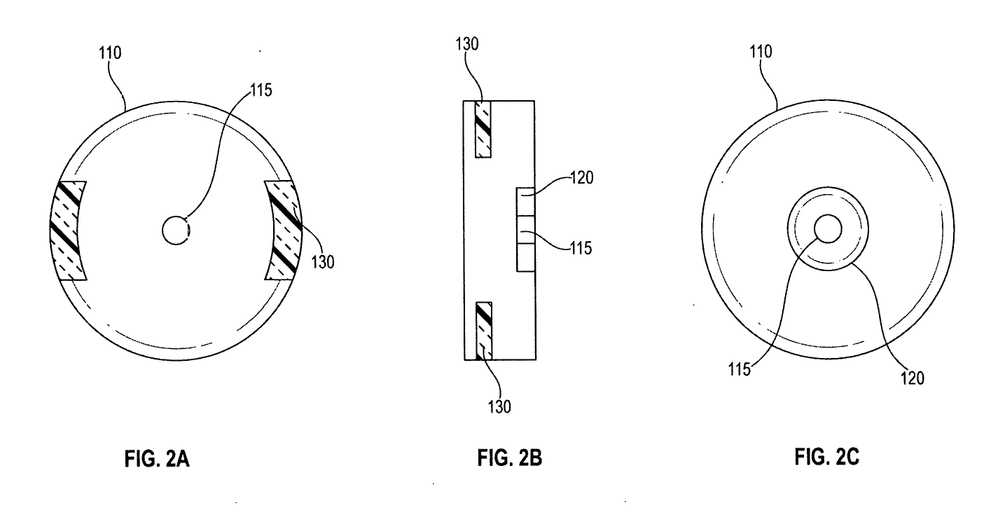

Referring now to FIG. 2A, a bottom view of a preferred embodiment of the anchor 110 is shown. The anchor 110 is preferably a single piece puck or spool. The anchor 110 can be made from a variety of materials such as a large array of plastics, wood materials, paper pulp materials, recycled materials, metals, rubbers, ceramics, or fiberglass. The anchor 110 shown is circular in shape but can also be any number of various effective shapes such as squares, triangles, oblongs, pyramids, circles, or spheres. In FIGS. 2A-2C, the preferred embodiment shown is a polypropylene plastic circle of 1.25-inch diameter with a depth on one side of approximately 0.375 inches. The preferred range of diameters for the anchor 110 is from 0.125 inches to 8+ inches. The anchor 110 preferably has a center hole 115 inside an eyelet depression 120. As shown in FIGS. 2A and 2B, the anchor 110 further preferably comprises a coil stay 130 around the circumference of the anchor 110. A line 150 is preferably attached to the anchor 110 through the center hole 115 and can be wrapped around the coil stay 130. One end of the line 150 preferably comprises an eyelet 155, namely a metal pin that will thread through the anchor center hole 115 and then pivot to a perpendicular position on an opposing end of the center hole 115 to secure the line 150 to the anchor 110.

The line 150 is preferably a single length of cord that can be made from a wide variety of composed natural fiber materials such as cotton, bamboo, palm fiber, or synthetic fiber materials such as polyethylene, polypropylene, nylon, urethane, carbon fiber, fiberglass, and glass, or metals such as steel, copper, or aluminum. Any and all of these line materials may be extruded, braided, coated, jacketed, wound or various combinations thereof. Alternately, the line 150 can be a flexible, steel, plastic jacketed wire or double wire of from 8 to 20 AWG gauge (not including the jacketing). The jacketing aids in preventing the wire (line) from cutting through corrugated material as well as cutting the user. The line 150 can have a variety of lengths depending on the application desired. However, a preferred range is 1 inch to 3 feet.

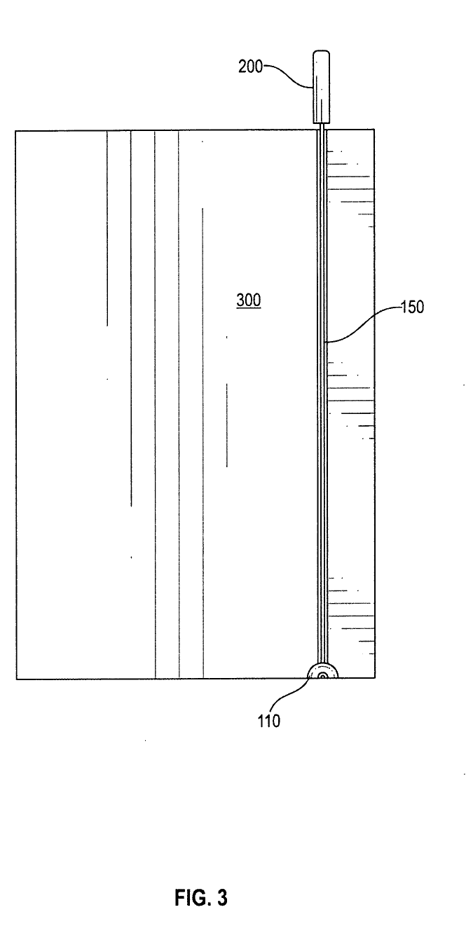

The line 150 should be of sufficient length to be retained by the anchor 110 inside a box and exit a corner or lip of a box such that it can be attached to the cinch 200. An example of a preferred embodiment of the invention installed in a package/envelope 300 is shown in FIG. 3.

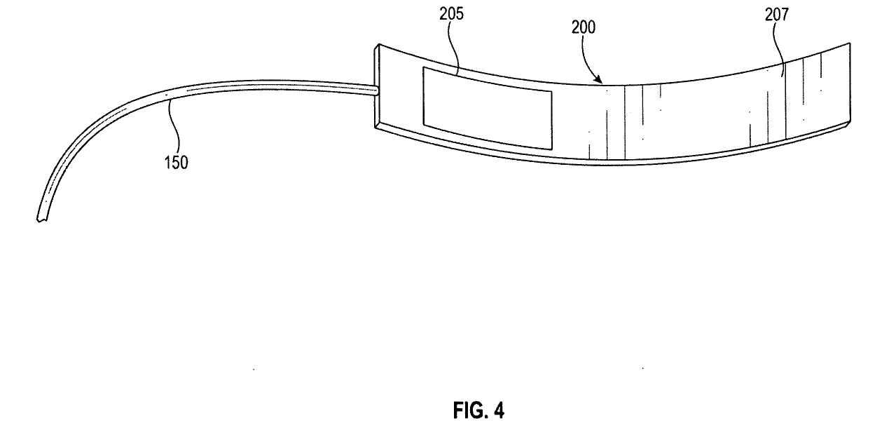

The cinch 200 preferably secures the line 150 and anchor 110 to a difficult to move surface and can be made in a variety of ways such as a mechanical padlock, a pre-configured loop knot, a ratchet tie, a split key ring, a locking cable key ring, a spring clip, a clip, a hook, or a belt. Referring to FIG. 4, a preferred embodiment of the cinch 200 is shown. Preferably, the cinch 200 at least partially comprises the same material as the line 150. The cinch 200 can also be a flexible wire coated with paper, plastic, woven or spun bonded material that would allow the cinch 200 to be looped through an attachment means and easily twisted back around and onto itself similar to a simple “bread bag tie”. The cinch 200 is preferably, as shown in FIG. 4, a single, separate, length of thermal, synthetic, plastic coated paper with a portion of one side 205 having a contact adhesive and a portion of the same side devoid of adhesive at a terminating end 207 of the cinch 200. The adhesive is preferably covered with an easy to peel release paper. Similar thermal paper tag configurations are seen in airline baggage tags. The preferred length of the entire synthetic paper cinch is from 3 inches to 36 inches. The preferred width ranges from 0.25 inches to 2 inches. Referring back to FIG. 3, the line 150 exiting the package 300 is shown integrated into the thermal paper tag cinch 200.

Preferably, when a package 300 is packed for shipping, the open end cinch loop 200 would be pulled out far enough from the package 300 to locate the terminating end 207 on the cinch 200 on one of the four corners of the package 300 exiting at the top to the outside or anywhere along the closed edges of the package 300. When the package 300 is closed by folding over two ninety degree folding flaps (one a top the other) and taped shut, the anchor 110 remains inside the package 300 and the preferably brightly colored cinch 200 is evident exiting one corner of the four corners of the closed package 300. Other types of closing boxes (not shown) could also be utilized. However, the cinch 200 would exit one of the un-taped corners or surfaces to the outside of the box. In use, when a delivery agent reaches a package destination or doorstep, he/she simply pulls the cinch 200 enough out of the package 300 to attach the cinch 200 to a house's fixed exterior object such as a door handle, secure ring or possibly a locking device located on the door knob, door or other difficult to move structure. A package recipient would then need to detach the cinch 200 from the difficult to move structure. This would not be overly difficult but it would be cumbersome enough to discourage “snatch and run” thefts.

### Version 2

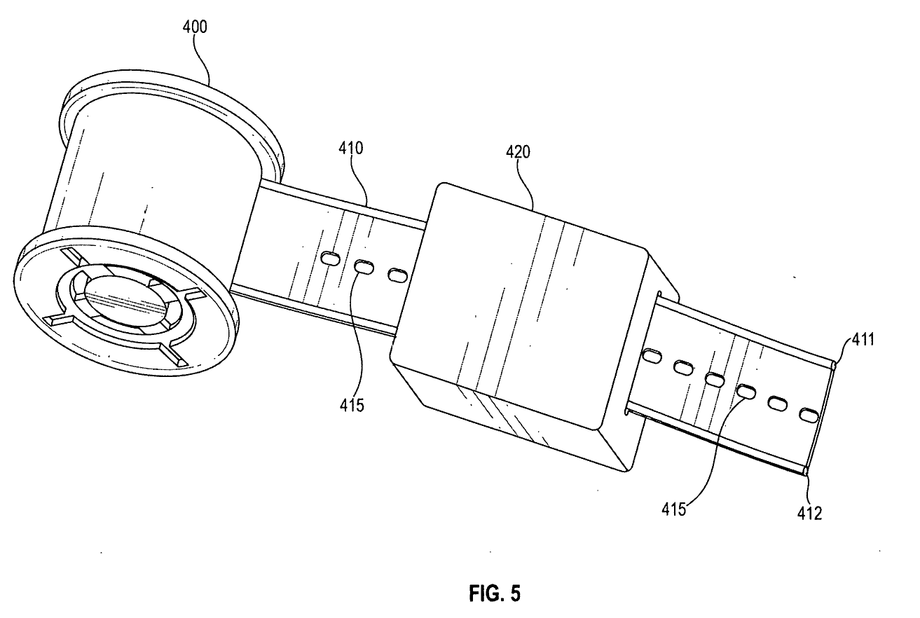

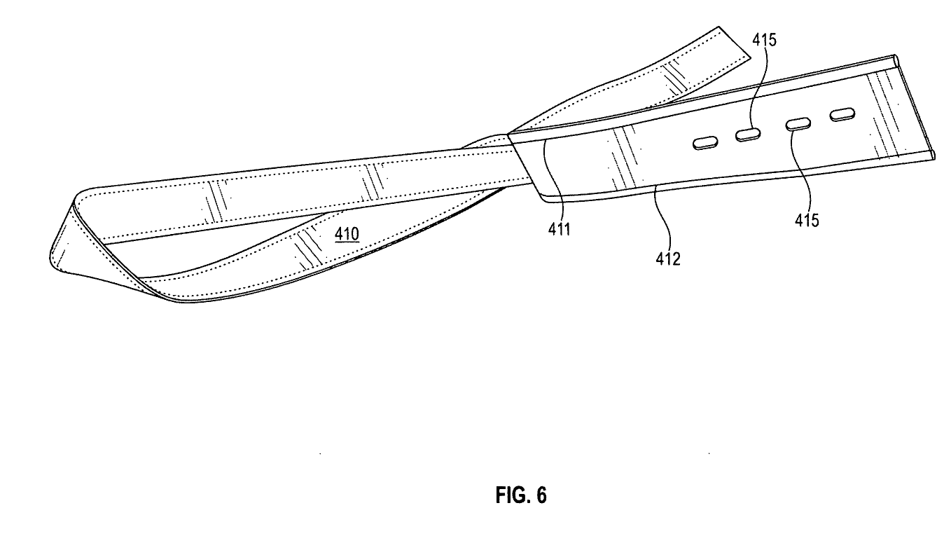

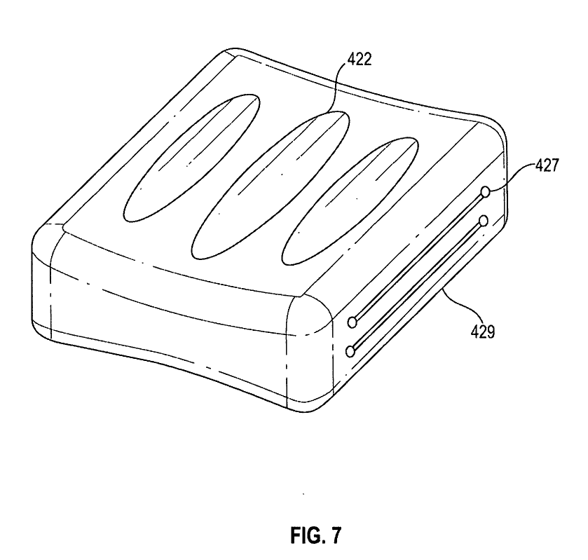

Referring now to FIG. 5, an alternative preferred embodiment of the package anchor is shown. The package anchor preferably comprises a spool 400 attached to a strap 410 with a zipper lock 420 slide-able on the strap 410. The strap 410 is preferably a plastic film encasing wires 411 and 412 on opposing sides of the strap 410. The wires 411 and 412 are preferably steel and preferably have a diameter of 0.50 mm to 1.0 mm. The strap 410 is preferably 20 mm wide and made from cut-resistant plastic. Preferably, the strap 410 further comprises holes 415 running along at least a portion of the length of the strap 410. The holes 415 are preferably 0.125″ in diameter and located at 0.5″ intervals along the strap's length. A preferred embodiment of the strap 410 is shown in FIG. 6.

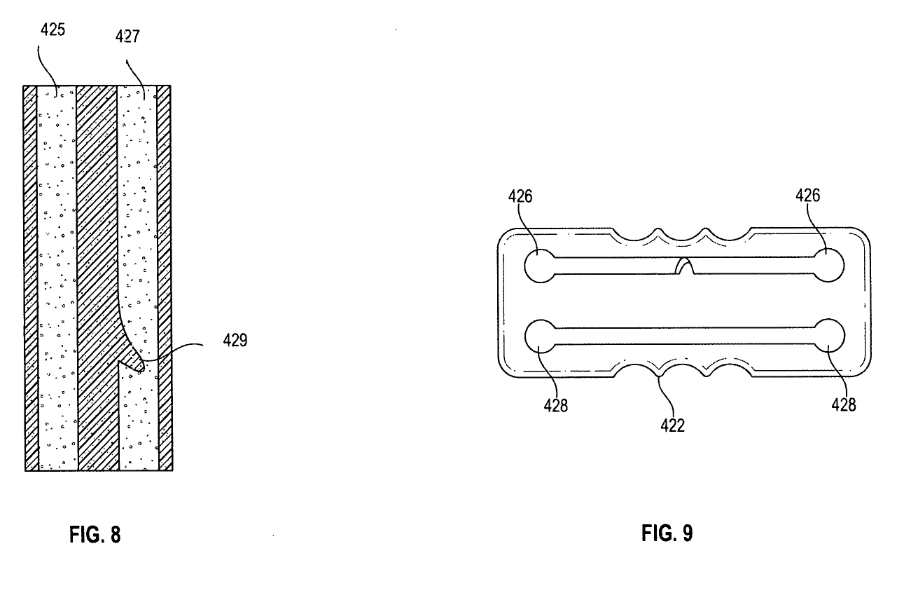

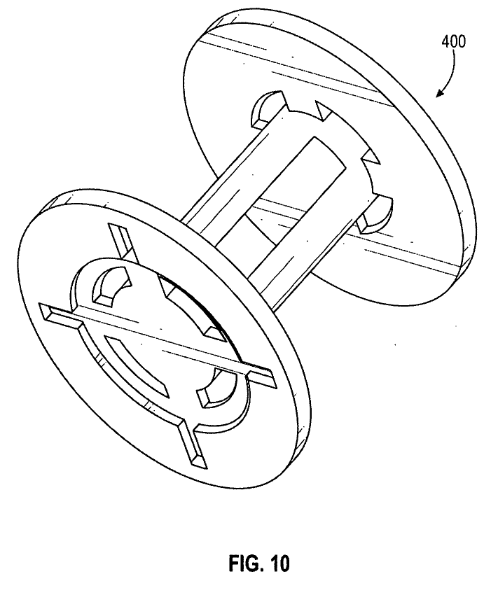

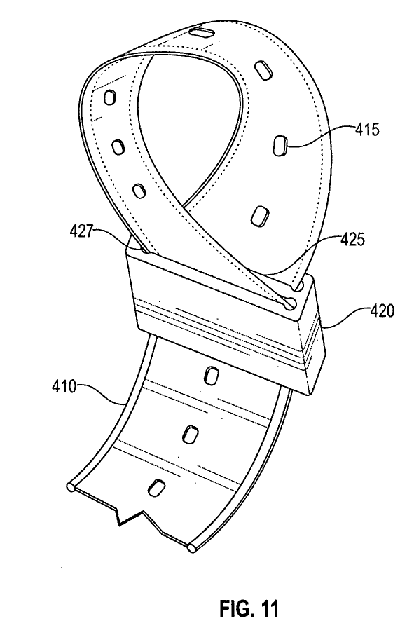

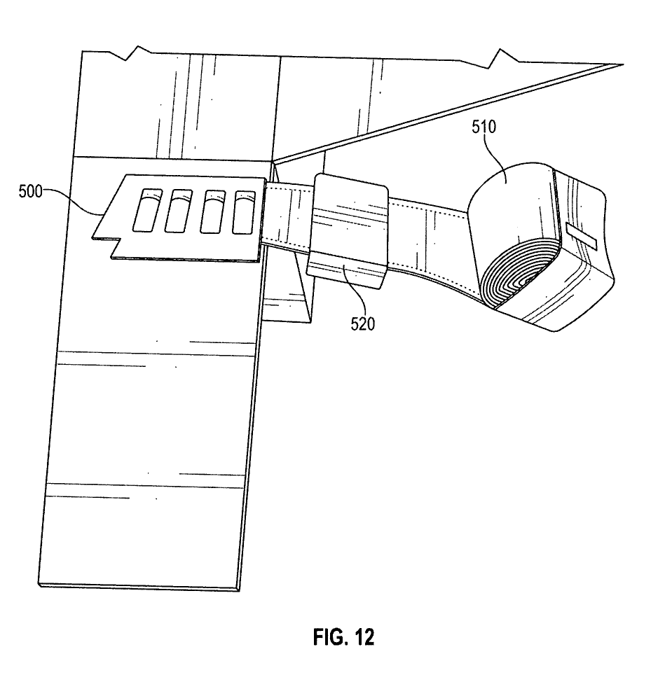

Referring now to FIG. 7, a perspective view of a preferred embodiment of the zipper lock 420 is shown. The zipper lock 420 preferably has grip scallops 422 to improve a user's grip on the zipper lock 420. Referring now to FIGS. 8 and 9, the zipper lock 420 further comprises a first slot 425, preferably with a smooth interior and wire channels 426 to guide the wires 411 and 412 of the strap 410, and a second slot 427 having wire channels 428 and an internal tooth 429. Thus, the strap 410 preferably passes through the first slot 425 and can be looped around a fixed object (not shown) and then passed back into and through the second slot 427. See FIG. 11. The strap 410, thus, may preferably move forward into the second slot 427 with little resistance but the holes 415 engage the internal tooth 429 and resist removal of the strap 410 from the zipper lock 420 when the strap 410 is moved in an opposing direction. The channels 426 and 428 are preferably 0.65 mm in diameter (when used with 0.5 mm wires in the strap 410) and the internal tooth preferably has a 0.12 mm curve. FIG. 8 is a side cross-sectional view of the zipper lock 420. A preferred embodiment of the spool 400 is shown in FIG. 10.

In preferred usage, the spool 400 is placed inside a package/box/carton with the zipper lock 420 and strap 410 protruding from the carton. When the carton is delivered, the delivery agent extends the strap 410 from the package and the strap 410 is then looped around a (relatively) fixed object such as a door knob/handle, railing, or the attachment ring described below. The strap 410 is then inserted into the second slot 427 of the zipper lock 420 until the strap 410 forms a tight loop and a hole 415 engages the internal tooth 429 in the zipper lock 420 to close the loop.

### Version 3

Another version of the package anchor is an integration of the cinch line or strap directly into the wall of a corrugated carton thus creating an integrated anchor and negating the need for a spool, puck or other device attached to the end of the cinch line. This version could be integrated several different ways such as a solid, flat, disk of plastic of a dimension from one inch in diameter up to six inches in diameter by one thirty second of an inch to one quarter of an inch thick affixed with an adhesive and laminated into a corrugated carton wall or carton flap. Preferably, the adhesive would be an amorphous shape of hot glue or other liquid, adhesive polymer, of a dimension from one to six inches in diameter of a cured hardness from 30 to 90 shore D, flooded between and into the corrugations of a carton wall or flap. The disk could also be attached to the package with a series of metal staples or one large metal staple or other attachment means directly to the top, bottom or side of the package walls or flaps.

While attachment of the strap to the carton is necessary to create an efficient means of securing a carton to an immovable object, it is also important that the strap itself exits the carton in a specific area of the carton and its attachment point is to a specific part of the carton. The strap should exit from the carton through any corner of the carton where the strap can easily lace through the two flap closures and exit an untapped or unsealed area.

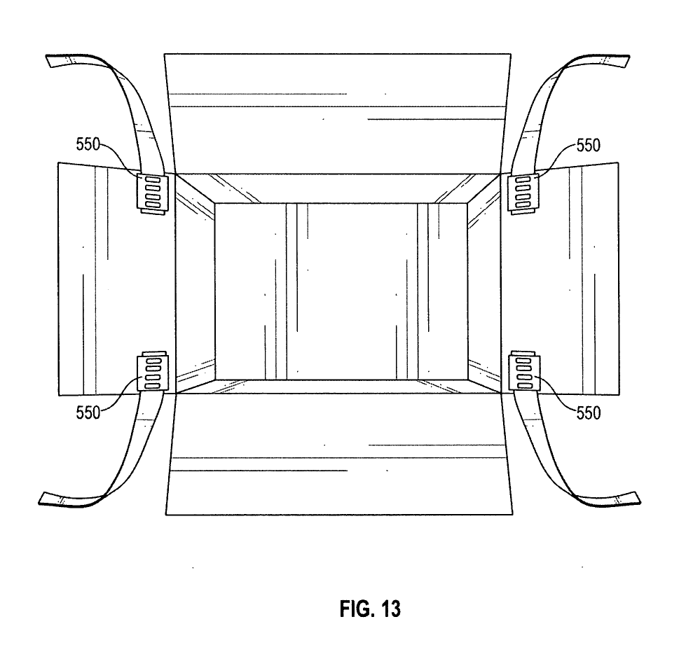

Referring now to FIG. 12, an alternative embodiment package anchor is shown. A strap 510 with a zipper lock 520 is mounted to a box/carton/package by a staple 500. The zipper lock 520 is preferably configured like the zipper lock in Version 2 above. The strap 510 is preferably configured like the strap in Version 2 above. The staple 500 is preferably metal. The strap 510 is preferably mounted by the staple 500 to one of four carton positions 550 shown in FIG. 13. These positions 550 are preferably 0.375 inches or less from a folding edge of an internal bi-folding flap and located at the end, outside edge of the flap on the box. This can be at any of the four carton positions 550. Locations progressively distant from these positions 550 provides a progressively greater mechanical advantage to defeat the package anchor by facilitating the strap 510 to become an angled cutting device when pulled at angles inside a closed carton and that can slice through side walls and thus, possibly detach the anchor from the box.

A more expensive means of preventing the strap 510 from becoming a cutting means would be insert an eyelet through a wall of the carton such that the strap 510 could pass through the carton to the outside of the carton. Such an eyelet would preferably be circular or oval in shape and molded from a polymer that would be integrated into the corrugated material during the manufacture of the carton. While such an eyelet would prevent most thin wires, cables or straps from being effective cutting means, such an eyelet could also be utilized as a means to integrate the strap into the corrugated carton walls on the inside by one of the means already described above.

### Attachment Ring

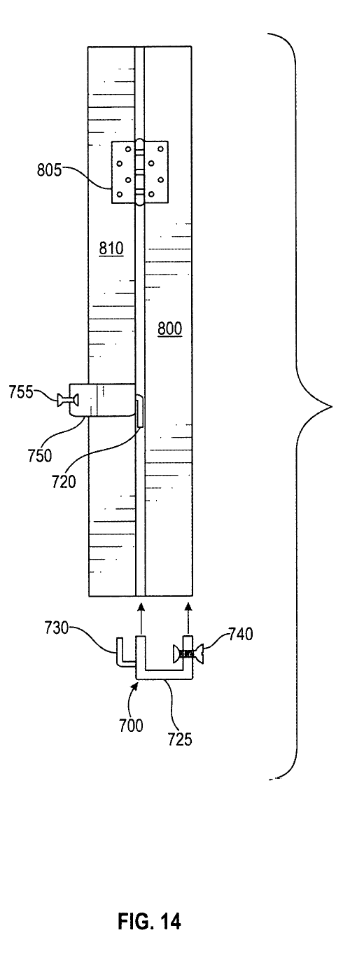

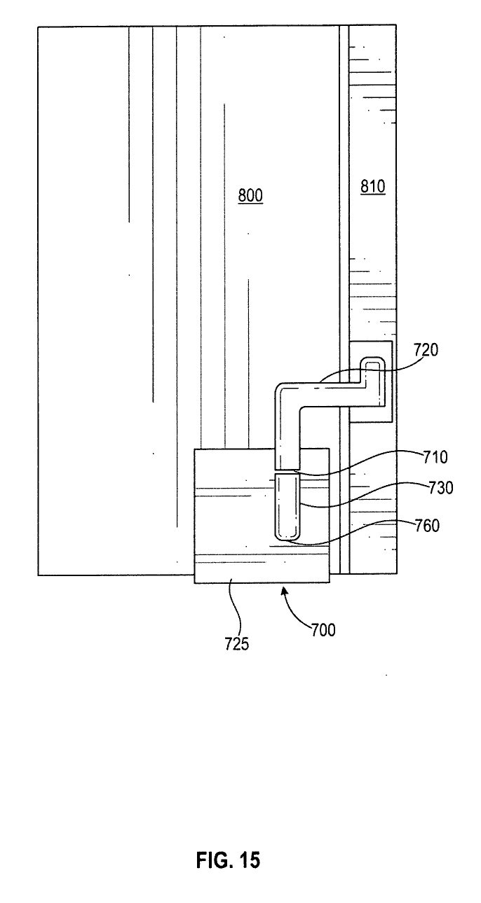

Referring now to FIGS. 14 and 15, a preferred embodiment of a two part attachment ring 700 is shown. The attachment ring 700 is preferably constructed of metal, plastic, or wood and has a fully or partially interlocking ring for securing the cinch 200 or strap 410/510 as described above. The cinch 200 and line 150 preferably secures the package 300 to a recipient's door 800 at the attachment ring 700. The attachment ring 700 preferably acts as a closed ring when a door is closed (as shown in FIG. 15) and an open ring when the door is opened allowing the removal of the cinch 200 (as shown in FIG. 14).

As shown in FIG. 14, the attachment ring door section 725 preferably has a vice screw 740 to attach the section 725 to the door 800. A U-shaped hook 730 is preferably mounted on a hook frame 725. The attachment ring frame section 750 shown in FIG. 14 is preferably attached to the door frame 810 by a vice screw 755 and has a downward hook 720. When the door frame 810 is closed, the sections 725 and 750 mesh together at the hook 730 and the downward hook 720 with a gap 710. This part 725 can also be attached on the outside of the door 800 as a screw 740 in the device capable of penetrating wood or other materials utilized in door frames. The attachment ring sections 750 and 725 could also be attached the door and/or frame with an adhesive or other attachment means.

Sections 750 and 725 when installed on a closed door 800 complete a closed ring. A cinch 200 or strap 410/510 and zipper lock 420/520 as described above can be securely attached thereto by a delivery agent to a closed ring 760. When a package recipient opens the door, the ring 760 opens and allows the cinch 200 or strap 410/510 to be easily slid off the hooks 720 or 730.

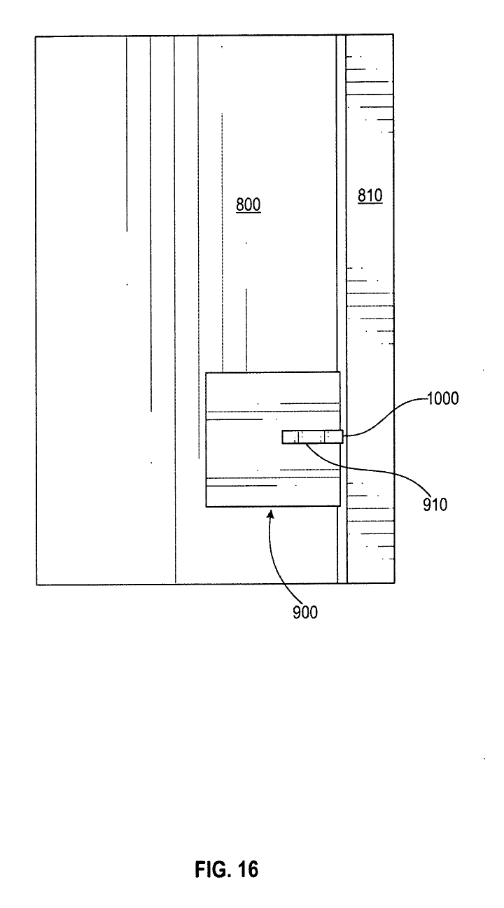

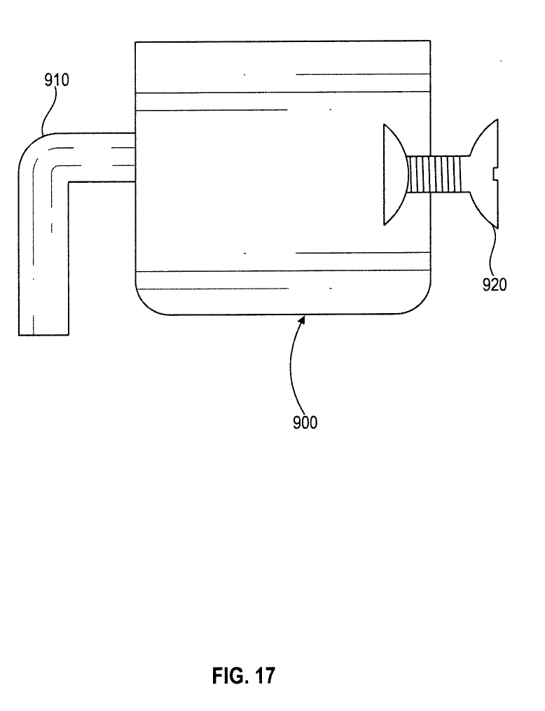

An alternative embodiment door hook 900 is shown in FIGS. 16 and 17. The alternative embodiment is preferably a single part system. As shown in FIG. 16, a U-shaped hook frame 900 is mounted to a door 800 with a vice screw 920 (shown in FIG. 17). When the door 800 is closed, the hook 910 preferably closes a gap 1000 between the door 800 and the doorframe 810. Preferably the gap 1000 is no less than 0.0625 inches. A cinch 200 or strap 410/510 can be inserted into the gap 1000 and placed around the hook 910 to secure a package (not shown).

Thus, an improved package anchor is described above that is a more effective deterrent to theft. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A package anchor for a package having folds comprising:
a line with a first end and a second end;
an anchor attached to the first end of the line and a cinch attached to the second end of the line;
where the line is attached to the anchor at a center hole; and
where the line is integral to the cinch;
the cinch has a first section and a second section where the first section has adhesive and the second section does not have adhesive; and,
the anchor is attached to the package between folds.

2. The package anchor of claim 1 where the line is also spooled onto the anchor.

3. The package anchor of claim 1 where the cinch is a twistable wire.

4. The package anchor of claim 1 where the anchor further comprises a pre-scored fold line.

5. A package anchor system for attaching a package to a door and a door frame, the system comprising:
a spool;
a strap, at least partially wrapped around the spool, the strap having a width with two wires separated by the width and where the wires are covered by plastic film with a center line having a plurality of holes; and,
a zipper lock slidable on the strap, the zipper lock having a first slot and a second slot where the second slot has an internal tooth.

6. The package anchor system of claim 5 where the system further comprises an attachment ring having a first part attached to a door frame and a second part attached to a door; where the strap is attachable to the attachment ring.

7. The package anchor system of claim 5 where the first part of the attachment ring comprises a U-shaped frame and hook and the second part of the attachment ring comprises a U-shaped frame and hook.

8. The package anchor system of claim 5 where the first slot and the second slot each has wire channels.

9. A package anchor system for attaching a package to a house with a fixed exterior object, the system comprising:
a staple attachable to the package;
a strap mounted to the staple, the strap having a width with two wires separated by the width and where the wires are covered by plastic film with a center line of a plurality of holes; and,
a zipper lock slidable on the strap, the zipper lock having a first slot and a second slot where the second slot has an internal tooth and where the first slot and second slot have wire channels.

10. The package anchor system of claim 9 where the staple is mounted to the package within 0.375 inches or less from a folding edge of an internal bi-folding flap and located at an outside edge of the flap on the package.
